(19) United States
(12) Patent Application Publication
(10) Pub. No.: US 2021/0075108 A1
(43) Pub. Date: Mar. 11, 2021

(54) COMMUNICATION DEVICE

(71) Applicants: ASKEY COMPUTER CORP., New Taipei City (TW); ASKEY TECHNOLOGY (JIANGSU) LTD., Jiangsu Province (CN)

(72) Inventors: Chih-Chung Lin, New Taipei City (TW); Chih-Cheng Chien, Taoyuan City (TW)

(73) Assignees: ASKEY COMPUTER CORP., NEW TAIPEI CITY (TW); ASKEY TECHNOLOGY (JIANGSU) LTD., Jiangsu Province (CN)

(21) Appl. No.: 16/821,982

(22) Filed: Mar. 17, 2020

(30) Foreign Application Priority Data
Sep. 5, 2019 (TW) 108131985

(51) Int. Cl. H01Q 7/00; H01Q 1/48; H01Q 5/307

(52) U.S. Cl. CPC H01Q 7/00; H01Q 5/307; H01Q 1/48

(57) ABSTRACT

A communication device includes a ground plane and an antenna element. The antenna element includes a first radiation portion and a second radiation portion. The first radiation portion includes a meander section and a rectangular metal section. The meander section has a rectangular hook-shaped structure. A feed point is disposed at a first end of the meander section, and a second end of the meander section is electrically connected to the rectangular metal section. A first end of the second radiation portion of an L-shaped structure is electrically connected to the ground plane. A first end of the rectangular metal section is spaced apart from a second end of the second radiation portion by a first parallel slot. The communication device operates in a first frequency band with the first radiation portion and the second radiation portion, and operates in a second frequency band with the first radiation portion.

### CROSS-REFERENCE TO RELATED APPLICATION

This application claims the priority of Taiwan application serial no. 108131985, filed on Sep. 5, 2019. The entirety of the above-mentioned patent application is hereby incorporated by reference herein and made a part of this specification.

### BACKGROUND

### Technical Field

The present disclosure relates to an electronic device, and more particularly to a communication device.

### Description of Related Art

With the development of wireless communication technology, consumers' demands for wireless communication quality or function are gradually increasing. In order to support various communication functions or meet the requirements for communication quality, existing wireless communication devices often need to be provided with multiple antennas, which makes it difficult to achieve miniaturization of size. Furthermore, in terms of the existing antenna structure, the size of the antenna is mainly determined by its operating frequency. Once the operating frequency band is expanded, the size of the antenna must be increased and it is less likely to achieve miniaturization. On the other hand, inconsideration of visual appearance or portability, the built-in antennas have become a trend for design, but the existing built-in antenna bandwidth and radiation efficiency are not ideal. Under this circumstance, how to ensure the bandwidth and radiation efficiency while miniaturizing the size has become an urgent problem to be solved.

### SUMMARY

The present disclosure provides a communication device capable of ensuring bandwidth and radiation efficiency while miniaturizing in size.

A communication device of the present disclosure includes a ground plane and an antenna element. The antenna element includes a first radiation portion and a second radiation portion. The first radiation portion includes a meander section and a rectangular metal section. The meander section has a rectangular hook structure. A feed point is disposed at a first end of the meander section, and a second end of the meander section is electrically connected to the rectangular metal section. The second radiation portion has an L-shaped structure. A first end of the second radiation portion is electrically connected to the ground plane. A first end of the rectangular metal section and a second end of the second radiation portion are spaced apart by a first parallel slot. The communication device is operated in a second frequency band through the first radiation portion, and the communication device is operated in a first frequency band through the first radiation portion and the second radiation portion.

Based on the above, the communication device of the present disclosure has a dual band working bandwidth. Specifically, the first radiation portion has a parallel bending structure, and the meander section of the first radiation portion can be used as a main resonant radiation element, and is resonant in the high frequency band based on a ⅛ wavelength. Moreover, the bandwidth of the high frequency band can be further expanded through the rectangular metal section of the first radiation portion and the second parallel slot. Furthermore, through the configuration that the rectangular metal section of the first radiation portion is connected to the meander section, and the rectangular metal section is provided with a second parallel slot at the first end so as to perform coupling resonance with the grounded second radiation portion having an inverted L-shape, it is possible for the communication device to operate in the low frequency band. In this way, the antenna working bandwidth of the communication device can be increased while the size can be minimized.

In order to make the aforementioned features and advantages of the disclosure more comprehensible, embodiments accompanying figures are described in detail below.

### BRIEF DESCRIPTION OF THE DRAWINGS

FIG. 1 is a schematic diagram of a communication device according to an embodiment of the present disclosure.

FIG. 2 is a schematic diagram of return loss of a communication device according to the embodiment of FIG. 1.

FIG. 3 is a schematic diagram of a voltage standing wave ratio of a communication device according to the embodiment of FIG. 1.

FIG. 4A to FIG. 4C are radiation pattern diagrams of the communication device according to the embodiment of FIG. 1 on the X-Y plane.

FIG. 5A to FIG. 5C are radiation pattern diagrams of the communication device according to the embodiment of FIG. 1 on the Y-Z plane.

FIG. 6A to FIG. 6C are radiation pattern diagrams of the communication device according to the embodiment of FIG. 1 on the X-Z plane.

### DESCRIPTION OF THE EMBODIMENTS

In the following embodiments, wordings used to indicate directions, such as “up,” “down,” “front,” “back,” “left,” and “right,” merely refer to directions in the accompanying drawings. Therefore, the directional wordings are used to illustrate rather than limit the disclosure. In the accompanying drawings, the drawings illustrate the general features of the methods, structures, and/or materials used in the particular exemplary embodiments. However, the drawings shall not be interpreted as defining or limiting the scope or nature covered by the exemplary embodiments. For example, the relative thickness and location of layers, regions, and/or structures may be reduced or enlarged for clarity.

In the embodiments, the same or similar elements will be designated by the same or similar reference numerals, and descriptions thereof will be omitted. In addition, the features of different exemplary embodiments may be combined with each other when they are not in conflict, and simple equivalent changes and modifications made according to the specification or the claims are still within the scope of the disclosure. In addition, the terms such as “first” and “second” mentioned in the specification or the claims are only used to name discrete elements or to distinguish different embodiments or scopes and are not intended to limit the upper or lower limit of the number of the elements, nor are they intended to limit the manufacturing order or disposition order of the elements.

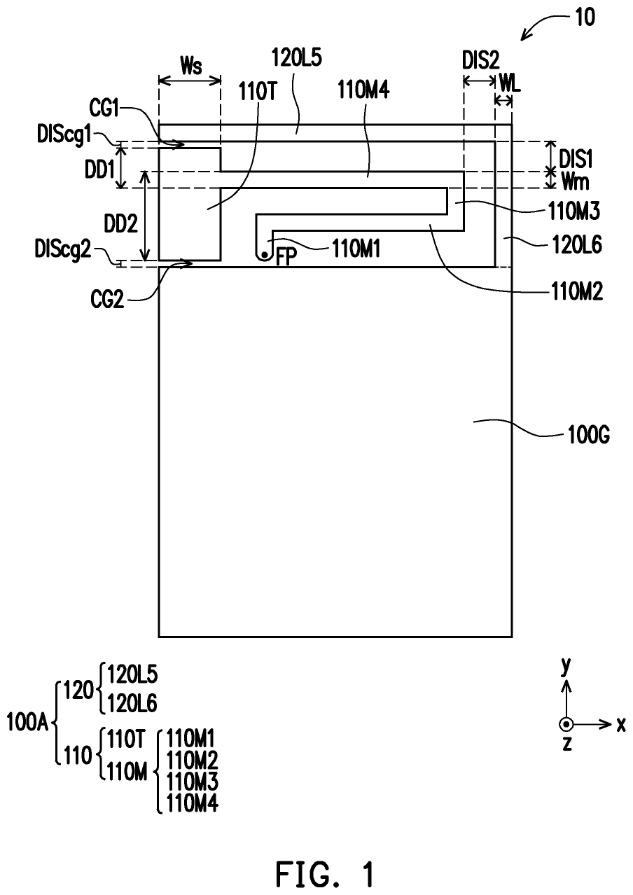

Please refer to FIG. 1. FIG. 1 is a schematic diagram of a communication device 10 according to an embodiment of the present disclosure. The communication device 10 includes a ground plane 100G and an antenna element 100A. In some embodiments, the ground plane 100G and the antenna element 100A are fabricated on the same printed circuit board (PCB), such as a glass epoxy resin copper foil (FR4) printed circuit board. In some embodiments, the ground plane 100G and the antenna element 100A are on the same plane; in other embodiments, the ground plane 100G and the antenna element 100A are on different planes, such as on different planes that are parallel to each other, respectively. Since the ground plane 100G and the antenna element 100A can be formed by punching or cutting a flat metal material or through a conductive substrate printing process, the production yield can be improved and the cost can be reduced. In some embodiments, the antenna element 100A is located in a clearance area, and the ground plane 100G is out of the clearance area, that is, the ground plane 100G or other grounding element is not disposed in the clearance area.

The antenna element 100A includes a first radiation portion 110 and a second radiation portion 120. The first radiation portion 110 includes a meander section 110M and a rectangular metal section 110T. A feed point FP is disposed at a first end of the meander section 110M, and a second end of the meander section 110M is electrically connected to the rectangular metal section 110T. The feed point FP can be coupled to a signal source (not shown) through a wire (not shown), and the signal source can be, for example, a transceiver of the communication device 10.

The rectangular metal section 110T has a straight structure, and the rectangular metal section 110T can be a rectangular metal element. The meander section 110M has a parallel bending structure. Specifically, the meander section 110M includes sections 110M1 to 110M4, wherein the sections 110M1 to 110M4 respectively have a straight structure. The section 110M2 (which may also be referred to as a second section) is electrically connected between the section 110M1 (which may also be referred to as a first section) and the section 110M3 (which may also be referred to as a third section); the section 110M4 (which may also referred to as a fourth section) is electrically connected between the section 110M3 and the rectangular metal section 110T. The feed point FP is disposed at one end of the section 110M1 of the meander section 110M. The section 110M4 is electrically connected to the rectangular metal section 110T, and one end (i.e., the second end of the meander section 110M) of the section 110M4 electrically connected to the rectangular metal section 110T is located between two opposite ends (i.e., between a first end and a second end of the rectangular metal section 110T) of the rectangular metal section 110T. That is, the rectangular metal section 110T extends from the section 110M4 toward the second radiation portion 120 and protrudes toward the second radiation portion 120.

In some embodiments, a bend is formed between the sections 110M1 and 110M2; a bend is formed between the sections 110M2 and 110M3; a bend is formed between the sections 110M3 and 110M4; and a bend is formed between the section 110M4 and the rectangular metal section 110T. Under the circumstance, the first radiation portion 110 is a curved polygonal line structure. In some embodiments, the first radiation portion 110 has a semiclosed structure, that is, the curved first radiation portion 110 does not form a closed pattern due to the lack of a partial section. In some embodiments, the section 110M1 is parallel to the section 110M3 and the rectangular metal section 110T, the section 110M2 is parallel to the section 110M4, that is, the first radiation portion 110 has a shape of parallel bending. In some embodiments, the section 110M2 is perpendicular to the sections 110M1 and 110M3 and the rectangular metal section 110T. In some embodiments, the meander section 110M generally has a rectangular hook-shaped structure or a U-shaped structure, that is, the sections 110M2 to 110M4 of the meander section 110M form a notch after bending. The rectangular metal section 110T is disposed opposite to the notch formed by the meander section 110M.

In some embodiments, at least one of the sections 110M1 to 110M4 of the meander section 110M has a width Wm, and the rectangular metal section 110T has a width Ws, wherein the extending directions of the widths Wm and Ws are perpendicular to the current direction, and thus the width Wm and Ws are related to the size of the cross-sectional area through which the current passes. In some embodiments, the sections 110M1 to 110M4 of the meander section 110M have equal widths Wm, and the rectangular metal section 110T has a uniform width Ws, but the present disclosure is not limited thereto.

On the other hand, a first end of the second radiation portion 120 is electrically connected to the ground plane 100G, and can be used as a ground end. The second radiation portion 120 includes sections 120L5 and 120L6, wherein the sections 120L5 and 120L6 respectively have a straight structure. The section 120L5 (which may also be referred to as a fifth section) is electrically connected between the section 120L6 (which may also be referred to as a sixth section) and the ground plane 100G. In some embodiments, a bend is formed between the sections 120L5 and 120L6; in some embodiments, the section 120L5 is perpendicular to the section 120L6. Under the circumstance, the second radiation portion 120 is a curved polygonal line structure and may have an L-shaped structure, for example, an inverted L-shaped ground. In some embodiments, the section 120L5 or the section 120L6 of second radiation portion 120 has a width WL, wherein the extending direction of the width WL is perpendicular to the current direction, and thus the width WL is related to the size of the cross-sectional area through which the current passes. In some embodiments, the sections 120L5 and 120L6 of the second radiation portion 120 have equal widths WL, but the disclosure is not limited thereto.

As shown in FIG. 1, the second radiation portion 120 partially surrounds the first radiation portion 110. In some embodiments, the first radiation portion 110 is spaced apart from the second radiation portion 120 by an unequal spacing. The rectangular metal section 110T is perpendicular to the section 120L5 of the second radiation portion 120, and the first end of the rectangular metal section 110T is space apart from the second end of the second radiation portion 120 by a first parallel slot CG1. The first parallel slot CG1 refers to that the edge of the first end of the rectangular metal section 110T is parallel to the edge of the second end of the second radiation portion 120 and the shape forms an open slot. The section 110M4 of the first radiation portion 110 is disposed in parallel with the section 120L5 of the second radiation portion 120 and spaced apart from each other by a distance DIS1. Similarly, the section 110M3 of the first radiation portion 110 is disposed in parallel with the section 120L6 of the second radiation portion 120 and spaced apart from each other by a distance DIS2. In some embodiments, the distance DIScg1 of the first parallel slot CG1 is different from the distance DIS1 (or the distance DIS2) such that the first radiation portion 110 and the second radiation portion 120 are spaced apart by an unequal spacing; in some embodiments, the distance DIScg1 of the first parallel slot CG1 is smaller than the distance DIS1 (or the distance DIS2).

As can be seen from the above, the first end of the rectangular metal section 110T is disposed adjacent to the second end of the second radiation portion 120, and are separated from each other without direct contact through the first parallel slot CG1 between the first end of the rectangular metal section 110T and the second end of the second radiation portion 120. Specifically, the first parallel slot CG1 can serve as a coupling gap, that is, a coupling can be formed between the first end of the rectangular metal section 110T and the second end of the second radiation portion 120, such as capacitive coupling. In this manner, the first radiation portion 110 and the second radiation portion 120 coupled to each other generate a loop surface current such that the surface current or current density at the slot portion (i.e., the first end of the rectangular metal section 110T and the second end of the second radiation portion 120) is maximized, thereby increasing the working bandwidth of antenna.

In some embodiments, the first radiation portion 110 and the second radiation portion 120 form a coupling mainly between the vicinity of the end point of the rectangular metal section 110T and the vicinity of the end point of the section 120L5. That is, the communication device 10 can form a coupling at the end point through the first radiation portion 110 and the second radiation portion 120. In order to ensure the coupling between the first radiation portion 110 and the second radiation portion 120, in some embodiments, the width Ws of the rectangular metal section 110T is larger than the width of the meander section 110M.

On the other hand, the second end of the rectangular metal section 110T is spaced apart from the ground plane 100G by a second parallel slot CG2. In some embodiments, the distance DIScg2 of the second parallel slot CG2 is smaller than the distance DIS1 (or the distance DIS2); that is, the second end of the rectangular metal section 110T is disposed adjacent to the ground plane 100G, and they are separated from each other without direct contact through the second parallel slot CG2 between the second end of the rectangular metal section 110T and the ground plane 100G. Specifically, the second parallel slot CG2 refers to that the edge of the second end of the rectangular metal section 110T is parallel to the edge of the ground plane 100G and the shape forms an open slot. The second parallel slot CG2 can serve as a coupling gap, that is, a coupling can be formed between the second end of the rectangular metal section 110T and the ground plane 100G, for example, capacitive coupling, such that a loop surface current can be generated between the first radiation portion 110 and the ground plane 100G. In this manner, the surface current or current density at the slot portion (i.e., the second end of the rectangular metal section 110T and the edge of the ground plane 100G) is maximized, thereby increasing the working bandwidth of antenna.

In some embodiments, the first radiation portion 110 forms the coupling with the ground plane 100G mainly near its end point. That is, the communication device 10 can form the coupling with the ground plane 100G at the end point through the first radiation portion 110. In order to ensure coupling between the first radiation portion 110 and the ground plane 100G, in some embodiments, the width WL of the second radiation portion 120 is smaller than the width Ws of the rectangular metal section 110T. That is, the ground plane 100G forms a coupling with the wider rectangular metal section 110T at the end point.

In the low frequency operation, through the configuration that the meander section 110M is connected to the rectangular metal section 10T, and the rectangular metal section 10T is provided with the second parallel slot CG2 at the first end so as to perform coupling resonance with the grounded second radiation portion 120 having an inverted L-shape, it is possible for the communication device 10 to operate in a working frequency band of 2.4 GHz. The loop surface current generated by the radiation metal (i.e., the first radiation portion 110 and the second radiation portion 120) of the coupling portion can increase the working bandwidth of antenna.

Specifically, in some embodiments, the meander section 110M of the first radiation portion 110, a part of the rectangular metal section 110T, the first parallel slot CG1, and the second radiation portion 120 may constitute a first resonance path, and the first resonance path can generate a first resonant mode corresponding to the first frequency band. That is, the communication device 10 can be operated in the first frequency band through the first radiation portion 110 and the second radiation portion 120. Specifically, the first frequency band can be a low frequency band, for example, a 2.4G frequency band (about 2.4 GHz to 2.5 GHz). Under the circumstance, the signal can be transmitted from the feed point FP to the meander section 110M and the rectangular metal section 110T of the first radiation portion 110, and then coupled from the first radiation portion 110 to the second radiation portion 120 through the first parallel slot CG1, and is grounded through the second radiation portion 120. In other words, through the first parallel slot CG1, the antenna element 100A can form an open loop antenna structure, and since the loop surface current is generated due to coupling of the first radiation portion 110 and the second radiation portion 120 at the first parallel slot CG1, not only that the working bandwidth of antenna can be increased, but also the first parallel slot CG1 helps to reduce the physical size of the antenna element 100A. In some embodiments, the length of a first resonance path of antenna element 100A is smaller than a ½ wavelength of (the center frequency of) the first frequency band; in some embodiments, the length of the first resonance path of the antenna element 100A a quarter wavelength of (the center frequency of) the first frequency band. Specifically, the length of the first resonance path is the sum of the length of the meander section 110M, the distance DD1, the distance DIScg1 of the first parallel slot CG1, and the length of the second radiation section 120. The distance DD1 (which may also be referred to as the first distance) is defined as the distance between the second end of the meander section 110M and the first end of the rectangular metal section 110T. As can be seen from the above, the antenna element 100A has a shorter characteristic length than conventional antenna elements, which contributes to miniaturization of the communication device 10.

In high frequency operation, the meander section 110M can be used as the main resonant radiation element, and the meander section 110M can obtain a working frequency range of 5 GHz through resonance based on a ⅛ wavelength, for example, the center frequency of the communication device 10 operated in the high frequency band can be 5.5 GHz. Moreover, through the configuration that the rectangular metal section 110T and the rectangular metal section 110T are coupled to ground at the second parallel slot CG2, the bandwidth can be further expanded, such that the communication device 10 can be operated between 4.9 GHz and 5.85 GHz.

Specifically, in some embodiments, the meander section 110M of the first radiation portion 110 is the main resonance path of the high frequency band. In some embodiments, in order to expand the bandwidth, the meander section 110M, the rectangular metal section 110T, and the second parallel slot CG2 of the first radiation portion 110 may constitute a second resonance path, and the second resonance path can generate a second resonant mode corresponding to the second frequency band. That is, the communication device 10 can be operated in a second frequency band through the first radiation portion 110. Specifically, the second frequency band can be a high frequency band, for example, a 5G frequency band (about 4900 MHz to 5850 MHz). Under the circumstance, the signal can be transmitted from the feed point FP to the meander section 110M and the rectangular metal section 110T of the first radiation section 110, and then coupled to the ground through the second parallel slot CG2. In other words, through the second parallel slot CG2, the antenna element 100A can form an open loop antenna structure, and the loop surface current generated by the first radiation portion 110 at the second parallel slot CG2 due to coupling not only can increase the working bandwidth of antenna, but also helps to reduce the physical size of the antenna element 100A. In some embodiments, the length of the second resonance path of antenna element 100A is smaller than a ½ wavelength of (the center frequency of) the second frequency band; in some embodiments, the length of the meander section 110M of antenna element 100A is a ⅛ wavelength of (the center frequency of) the second frequency band. Specifically, the length of the second resonance path is the sum of the length of the meander section 110M, the distance DD2, and the distance DIScg2 of the second parallel slot CG2. The distance DD2 is defined as the distance between the second end of the meander section 110M, the width of the section 110M4 and the second end of the rectangular metal section 110T. As can be seen from the above, the antenna element 100A has a shorter characteristic length than conventional antenna elements, which contributes to miniaturization of the communication device 10.

As can be seen from the above, the antenna element 100A of the communication device 10 has two resonance paths, and can be operated in a dual band of a first frequency band (for example, a low frequency band) and a second frequency band (for example, a high frequency band). In order to further ensure impedance matching, in some embodiments, the feed point FP is disposed adjacent to the second end (which may also be referred to as a coupling ground end) of the rectangular metal section 110T, and the feed point FP and the second end of the rectangular metal section 110T are disposed away from the first end (which may also be referred to as a ground end) of the second radiation portion 120. That is, for the first resonance path, the first end of the meander section 110M for setting the feed point FP is disposed away from the first end of the second radiation portion 120 for grounding; for the second resonance path, the first end of the meander section 110M for setting the feed point FP is disposed adjacent to the second end of the rectangular metal section 110T for coupling to ground. However, the disclosure is not limited thereto, and the positions of the ground end and the feeding end can be appropriately adjusted according to different design considerations.

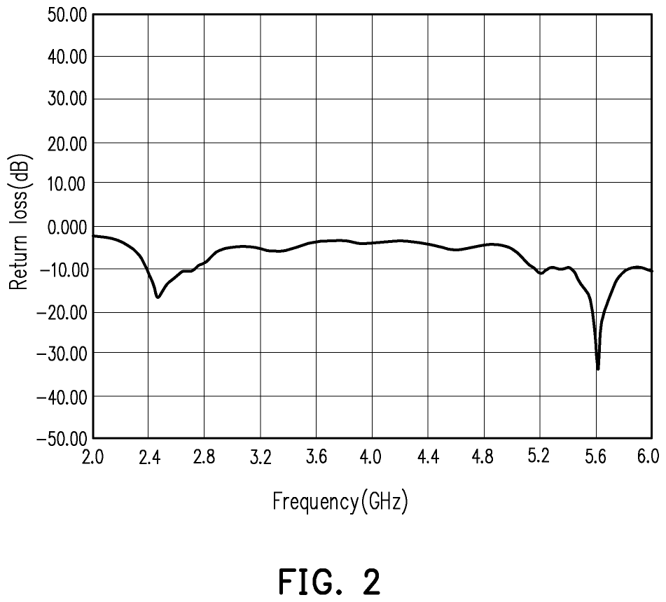

Please refer to FIG. 2. FIG. 2 is a schematic diagram of return loss of the communication device 10 according to the embodiment of FIG. 1. As can be seen from FIG. 2, the return loss of the communication device 10 is −11.016 dB at 2.402 GHz, −15.342 dB at 2.45 GHz, −16.246 dB at 2.48 GHz, −10.278 dB at 5.18 GHz, −9.9264 dB at 5.35 GHz. GHz, −13.566 dB at 5.5 GHz, −13.011 dB at 5.745 GHz, and −9.8891 dB at 5.85 GHz. That is to say, through the structural design of the antenna element 100A, in the operating frequency band to be covered by the communication device 10, the return loss of the communication device 10 is less than −9.5 dB, and can be used as an ideal dual frequency open loop antenna.

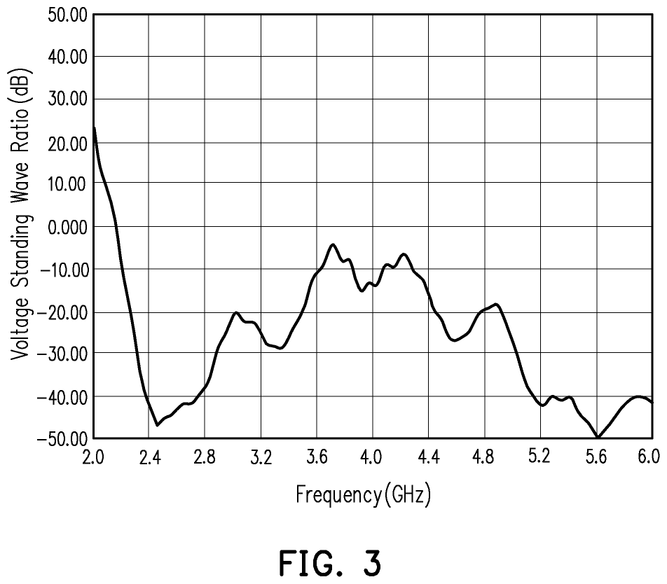

Please refer to FIG. 3. FIG. 3 is a schematic diagram of a voltage standing wave ratio (VSWR) of the communication device 10 according to the embodiment of FIG. 1. As can be seen from FIG. 3, the antenna voltage standing wave ratio is 1.7939 to 1 at 2.402 GHz, 1.4205 to 1 at 2.45 GHz, 1.3721 to 1 at 2.48 GHz, 1.8847 to 1 at 5.18 GHz, 1.9291 to 1 at 5.35 GHz, 1.5269 to 1 at 5.5 GHz, 1.5711 to 1 at 5.745 GHz, 3.4121 to 1 at 5.745 GHz, and 1.9433 to 1 at 5.85 GHz. That is to say, through the structural design of the antenna element 100A, in the operating frequency band to be covered by the communication device 10, the voltage standing wave ratio of the communication device 10 is smaller than 2.0 to 1, and can be used as an ideal dual frequency open loop antenna.

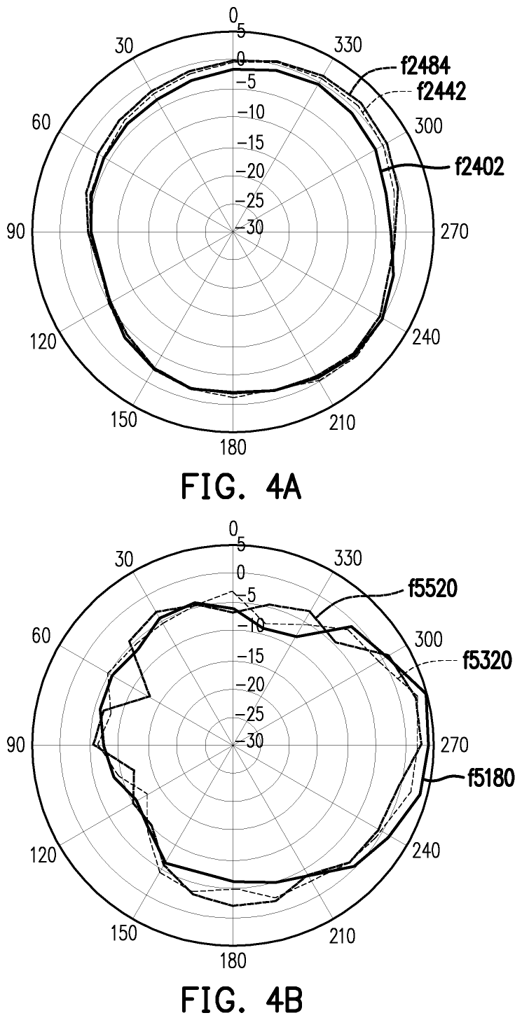

Please refer to FIG. 4A to FIG. 4C, FIG. 4A to FIG. 4C are radiation pattern diagrams of the communication device 10 according to the embodiment of FIG. 1 on the X-Y plane. The number on the circumference is the degree of circumference, the distance between the curve and the center of the radiation pattern corresponds to the gain, and the unit thereof is decibel (dB). The curve f2402 (solid line), the curve f2442 (thin dashed line) and the curve f2484 (thick dashed line) in FIG. 4A respectively correspond to the radiation patterns of the communication device 10 at 2.402 GHz, 2.442 GHz, and 2.484 GHz. The curve f5180 (solid line), the curve f5320 (thin dashed line), and the curve f5520 (thick dashed line) in FIG. 4B respectively correspond to the radiation patterns of the communication device 10 at 5.180 GHz, 5.320 GHz, and 5.520 GHz. The curve f5720 (solid line), the curve f5825 (thin dashed line), and the curve f5835 (thick dashed line) in FIG. 4C respectively correspond to the radiation patterns of the communication device 10 at 5.720 GHz, 5.825 GHz and 5.835 GHz. As can be seen from FIG. 4A to FIG. 4C, since the design of the second resonance path is different from the design of the first resonance path, the patterns of the communication device 10 in different frequency bands are not entirely the same. Even if the directivity is slightly different, under the structural arrangement of the antenna element 100A, the radiation pattern of the communication device 10 on the X-Y plane is approximately omnidirectional radiation and has good signal transceiving capability.

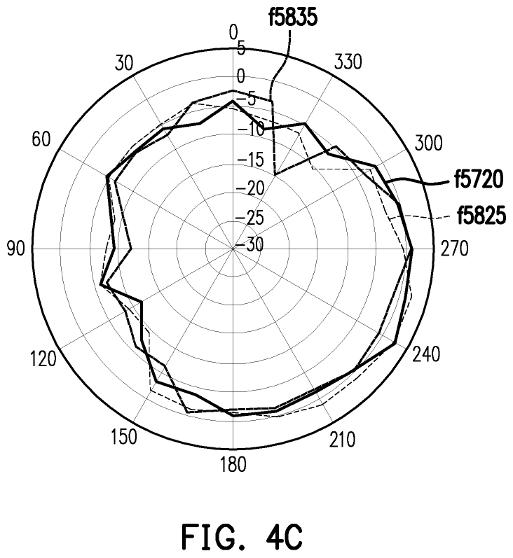

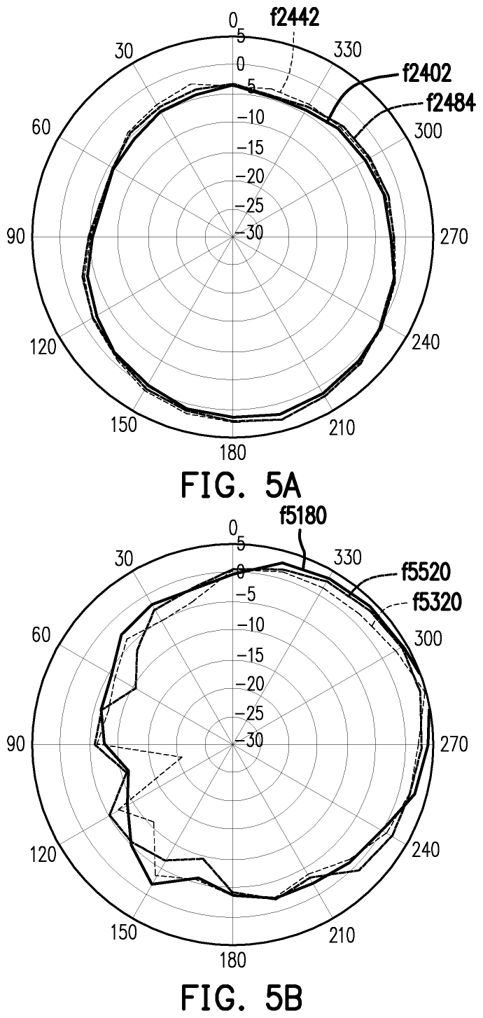

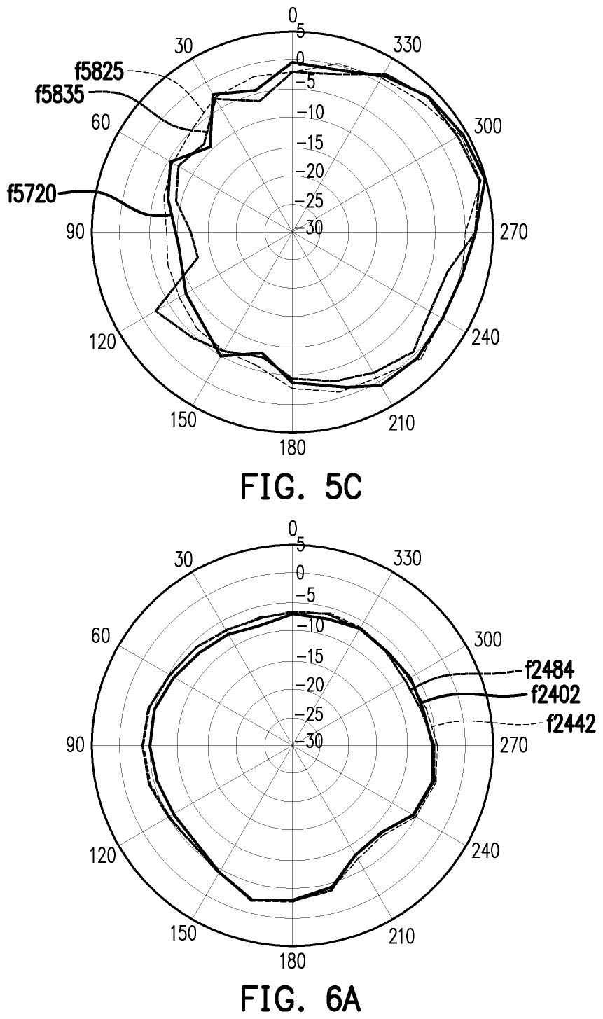

Referring to FIG. 5A to FIG. 5C, FIG. 5A to FIG. 5C are radiation pattern diagrams of the communication device 10 according to the embodiment of FIG. 1 on the Y-Z plane. The curve f2402 (solid line), the curve f2442 (thin dashed line), and the curve f2484 (thick dashed line) in FIG. 5A respectively correspond to the radiation patterns of the communication device 10 at 2.402 GHz, 2.442 GHz, and 2.484 GHz. The curve f5180 (solid line), the curve f5320 (thin dashed line) and the curve f5520 (thick dashed line) in FIG. 5B respectively correspond to the radiation patterns of the communication device 10 at 5.180 GHz, 5.320 GHz and 5.520 GHz. The curve f5720 (solid line), the curve f5825 (thin dashed line) and the curve f5835 (thick dashed line) in FIG. 5C respectively correspond to the radiation patterns of the communication device 10 at 5.720 GHz, 5.825 GHz, and 5.835 GHz. As can be seen from FIG. 5A to FIG. 5C, since the design of the second resonance path is different from the design of the first resonance path, the patterns of the communication device 10 in different frequency bands are not entirely the same. Even if the directivity is slightly different, under the structural arrangement of the antenna element 100A, the radiation pattern of the communication device 10 on the Y-Z plane is approximately omnidirectional radiation and has good signal transceiving capability.

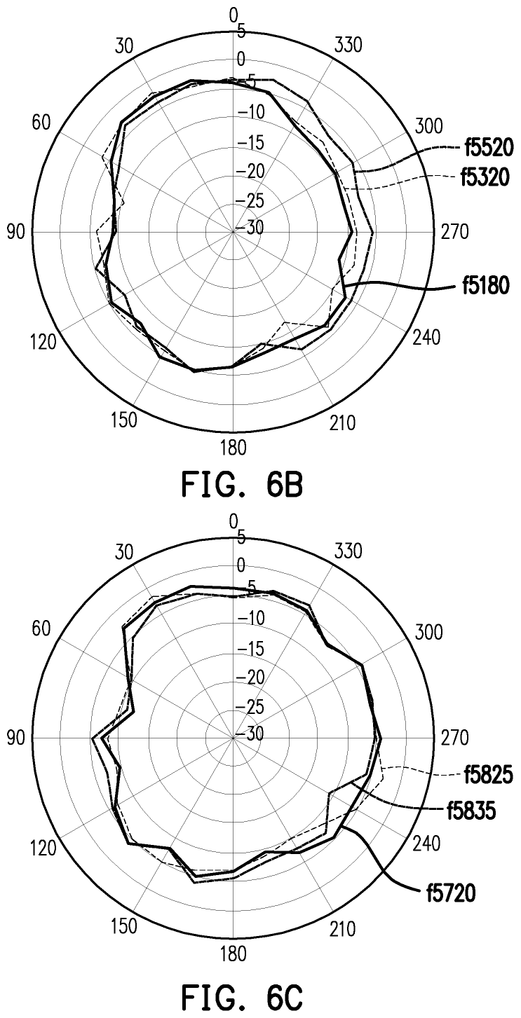

Please refer to FIG. 6A to FIG. 6C, FIG. 6A to FIG. 6C are radiation pattern diagrams of the communication device 10 according to the embodiment of FIG. 1 on the X-Z plane. The curve f2402 (solid line), the curve f2442 (thin dashed line), and the curve f2484 (thick dashed line) in FIG. 6A respectively correspond to the radiation patterns of the communication device 10 at 2.402 GHz, 2.442 GHz, and 2.484 GHz. The curve f5180 (solid line), the curve f5320 (thin dashed line) and the curve f5520 (thick dashed line) in FIG. 6B respectively correspond to the radiation patterns of the communication device 10 at 5.180 GHz, 5.320 GHz and 5.520 GHz. The curve f5720 (solid line), the curve f5825 (thin dashed line) and the curve f5835 (thick dashed line) in FIG. 6C respectively correspond to the radiation patterns of the communication device 10 at 5.720 GHz, 5.825 GHz, and 5.835 GHz. As can be seen from FIG. 6A to FIG. 6C, since the design of the second resonance path is different from the design of the first resonance path, the patterns of the communication device 10 in different frequency bands are not entirely the same. Even if the directivity is slightly different, under the structural arrangement of the antenna element 100A, the radiation pattern of the communication device 10 on the X-Z plane is approximately omnidirectional radiation and has good signal transceiving capability.

Referring to Table 1, Table 1 is an antenna characteristic table of the communication device 10 according to the embodiment of FIG. 1. Table 1 corresponds to FIG. 4A to FIG. 6C and shows the peak gain and the average gain of the communication device 10 in different frequencies on the X-Y plane, the Y-Z plane, and the X-Z plane. As can be seen from Table 1, the communication device 10 has a high gain under the structural configuration of the antenna element 100A described above.

| | X−Y plane | | Y−Z plane | | X−Z plane | |
|---|---|---|---|---|---|---|
| Frequency | | Average | | Average | | Average |
| (GHz) | Peak gain | gain | Peak gain | gain | Peak gain | gain |
| 2.402 | 0.33 | −2.08 | 1.90 | −1.74 | 1.75 | −2.23 |
| 2.442 | 1.00 | −1.41 | 2.69 | −1.10 | 1.87 | −1.67 |
| 2.484 | 1.52 | −1.33 | 2.73 | −1.22 | 1.72 | −1.81 |
| 5.180 | 4.04 | −2.28 | 5.38 | −0.19 | 1.15 | −2.79 |
| 5.320 | 2.99 | −2.56 | 4.64 | −0.96 | 1.59 | −2.61 |
| 5.520 | 2.82 | −2.64 | 3.94 | −0.32 | 1.07 | −2.09 |
| 5.720 | 2.84 | −2.42 | 4.46 | −0.89 | 1.16 | −1.95 |
| 5.825 | 2.65 | −2.13 | 3.74 | −1.20 | 1.99 | −2.09 |
| 5.835 | 1.25 | −2.95 | 3.52 | −1.71 | 0.35 | −2.22 |

In summary, the communication device 10 of the present disclosure has a dual band working bandwidth. Specifically, the first radiation portion 110 has a parallel bending structure, and the meander section 110M of the first radiation portion 110 can be used as a main resonant radiation element, and is resonant in the high frequency band based on a ⅛ wavelength. Moreover, the bandwidth of the high frequency band can be further expanded through the rectangular metal section 110T of the first radiation portion 110 and the second parallel slot CG2. Furthermore, through the configuration that the rectangular metal section 110T of the first radiation portion 110 is connected to the meander section 110M, and the rectangular metal section 110T is provided with a second parallel slot CG2 at the first end so as to perform coupling resonance with the grounded second radiation portion 120 having an inverted L-shape, it is possible for the communication device 10 to operate in the low frequency band. In this way, the antenna working bandwidth of the communication device 10 can be increased while the size can be minimized.

Although the present disclosure has been disclosed in the above embodiments, it is not intended to limit the present disclosure, and those skilled in the art can make some modifications and refinements without departing from the spirit and scope of the disclosure. Therefore, the scope to be protected by the present disclosure is subject to the scope defined by the appended claims.

What is claimed is:

1. A communication device, comprising:
a ground plane; and
an antenna element, comprising:
a first radiation portion comprising a meander section and a rectangular metal section, the meander section having a rectangular hook-shaped structure, a feed point disposed at a first end of the meander section, a second end of the meander section electrically connected to the rectangular metal section; and
a second radiation portion having an L-shaped structure, a first end of the second radiation portion being electrically connected to the ground plane, a first end of the rectangular metal section and a second end of the second radiation portion being spaced apart by a first parallel slot, wherein the communication device is operated in a first frequency band through the first radiation portion and the second radiation portion, and the communication device is operated in a second frequency band through the first radiation portion.

2. The communication device of claim 1, wherein the meander section comprises:
a first section, the feed point disposed at one end of the first section;
a second section electrically connected to the first section, and a bend being formed between the first section and the second section;
a third section electrically connected to the second section, a bend being formed between the third section and the second section, the third section being parallel to the first section;
a fourth section electrically connected between the rectangular metal section and the third section, a bend being formed between the third section and the fourth section, and the fourth section is parallel to the second section.

3. The communication device of claim 1, wherein the meander section, a part of the rectangular metal section, the first parallel slot and the second radiation portion constitute a first resonance path, the first resonance path generates a first resonance mode corresponding to the first frequency band.

4. The communication device of claim 1, wherein the second end of the meander section is spaced apart from the first end of the rectangular metal section by a first distance, a length of the first resonance path of the antenna element corresponds to a quarter wavelength of the first frequency band, the length of the first resonance path is the sum of a length of the meander section, the first distance, a distance of the first parallel slot, and a length of the second radiation portion.

5. The communication device of claim 1, wherein a second end of the rectangular metal section is spaced apart from the ground plane by a second parallel slot.

6. The communication device according to claim 5, wherein the meander section, the rectangular metal section, and the second parallel slot constitute a second resonance path, the second resonance path generates a second resonance mode corresponding to the second frequency band.

7. The communication device of claim 1, wherein a length of the meander section of the antenna element corresponds to a ⅛ wavelength of the second frequency band.

8. The communication device of claim 1, wherein the antenna element forms an open loop antenna structure.

9. The communication device of claim 1, wherein the second end of the meander section is located between the first end and a second end opposite to each other of the rectangular metal section.

10. The communication device of claim 1, wherein the rectangular metal section has a width larger than a width of the meander section.
